(19) United States
(12) Patent Application Publication
(10) Pub. No.: US 2009/0069034 A1
(43) Pub. Date: Mar. 12, 2009

(54) Neighbor to neighbor relay in a geo-spatial environment

(75) Inventor: Raj Abhyanker, Cupertino, CA (US)

Correspondence Address: PILLSBURY WINTHROP SHAW PITTMAN LLP, P.O. BOX 10500, MCLEAN, VA, 22102, US

(73) Assignee: Fatdoor, Inc

(21) Appl. No.: 11/900,364

(22) Filed: Sep. 10, 2007

(51) Int. Cl. H04Q 7/20

(52) U.S. Cl. 455/456.3

(57) ABSTRACT

A method and system of neighbor to neighbor relay in a geo-spatial environment are disclosed. In one embodiment, a method of managing a community network includes obtaining member data associated with a member of the community network, determining a location of the member based on the member data, storing the member data in a member repository, obtaining a number of profiles in the community network corresponding to a number of neighbors of the member based on the member data and the location, generating a neighbor to neighbor introduction using the member data and the profiles by forming a chain between neighbors such that one neighbor introduces a group formed between neighbors in the chain to another neighbor such that a neighbor to neighbor relay is formed in a geo-spatial social network, and facilitating the introduction between the member and a profiles using the neighbor to neighbor relay.

### FIELD OF TECHNOLOGY

This disclosure relates generally to the technical fields of communications and, in one example embodiment, to a method, apparatus, and system of neighbor to neighbor relay in a geo-spatial environment.

### BACKGROUND

A person may know or be able to recognize neighbors immediately next to the home of the person. For example, the person may know or recognize the name, email, profession, and/or phone number of a neighbor who lives immediately adjacent to the person's home (e.g., a neighbor across the street). However, the person may not know or recognize names of neighbors who live around a corner and/or a few homes away from the person.

The neighbor across the street may know a different group of neighbors than the person. The person may benefit socially, professionally and/or academically should the person get to know the different group of neighbors (e.g., may be walking distance away and/or may have shared interests). However, the person may speak with the neighbor across the street infrequently. As such, there may be few opportunities for the neighbor across the street to introduce the person to the different group of neighbors.

### SUMMARY

A method and system of neighbor to neighbor relay in a geo-spatial environment are disclosed. In one aspect, a method of managing a community network includes obtaining member data associated with a member of the community network, determining a location of the member based on the member data, storing the member data in a member repository, obtaining a plurality of profiles in the community network corresponding to a plurality of neighbors of the member based on the member data and the location, generating a neighbor to neighbor introduction using the member data and the profiles by forming a chain between neighbors such that one neighbor introduces a group formed between neighbors in the chain to another neighbor such that a neighbor to neighbor relay is formed in a geo-spatial social network, and facilitating the introduction between the member and the profiles using the neighbor to neighbor relay.

In addition, the method may include displaying the profiles and the member data on a geo-spatial map. The method may also include obtaining an introduction request including a sending profile and a receiving profile from the member, sending the introduction request to a first of the profiles corresponding to the sending profile, and receiving the introduction (e.g., may include an introduction message, a sending profile, an introduction profile, a receiving profile, and an acceptance status) of the member from the first of the profiles to a second of the profiles corresponding to the receiving profile, and sending the introduction to the receiving profile.

The method may further include receiving an acceptance of the introduction from the receiving profile, and creating a connection between the member and the receiving profile based on the acceptance. In addition, the method may include obtaining the introduction including an introduction profile and a receiving profile from the member, and sending the introduction of a first of the profiles corresponding to the introduction profile to a second of the profiles corresponding to the receiving profile. The method may further include receiving an acceptance of the introduction profile from the receiving profile, and creating a connection between the introduction profile and the receiving profile based on the acceptance.

The method may also include obtaining the introduction from a first of the profiles corresponding to a sending profile of a second of the profiles corresponding to an introduction profile, and sending the introduction to the member. The method may also include receiving an acceptance of the introduction from the member, and creating a connection between the introduction profile and the member based on the acceptance.

In another aspect, a community network includes a member repository including a plurality of members, a geo-spatial repository including a plurality of locations on a geo-spatial map, a member management module configured to obtain member data (e.g., may include a location) associated with each of the members, and a member introduction module configured to obtain a subset of the members corresponding to a plurality of neighbors of a member based on the member data and the location, generate a neighbor to neighbor relay using the member data and the subset of the members, display the neighbor to neighbor relay to the member, and facilitate an introduction between the members and the subset of the members using the neighbor to neighbor relay.

The geo-spatial repository may be configured to display the subset of the members and the member data on a geo-spatial map. The member introduction module may be configured to obtain an introduction request including a sending profile and a receiving profile from the member, send the introduction request to a first of the subset corresponding to the sending profile, and receive an introduction (e.g., may include an introduction message, a sending profile, an introduction profile, a receiving profile, and/or an acceptance status) of the member from the first of the subset to a second of the subset corresponding to the receiving profile, send the introduction to the receiving profile, receive an acceptance of the introduction from the receiving profile, and create a connection between the member and the receiving profile based on the acceptance.

The member introduction module may further be configured to obtain the introduction including an introduction profile and a receiving profile from the member, send the introduction of a first of the subset corresponding to the introduction profile to a second of the subset corresponding to the receiving profile, receive an acceptance of the introduction from the receiving profile, and create a connection between the introduction profile and the receiving profile based on the acceptance.

In addition, the member introduction module may be configured to obtain the introduction from a first of the subset corresponding to a sending profile of a second of the subset corresponding to an introduction profile, send the introduction to the member, receive an acceptance of the introduction from the member, and create a connection between the introduction profile and the member based on the acceptance.

In yet another aspect, a method of managing a community network includes obtaining a neighborhood in the community network, obtaining a location of the neighborhood, obtaining a neighborhood boundary corresponding to the neighborhood, determining a plurality of profiles in the community network corresponding to the neighborhood based on the location and the neighborhood boundary, obtaining a plurality of connections corresponding to the profiles, generating a neighbor to neighbor relay using the profiles and the connections, and facilitating introductions between the profiles using the neighbor to neighbor relay.

The method may further include receiving an introduction request including a sending profile and a receiving profile from a first of the profiles, sending the introduction request to a second of the profiles corresponding to the sending profile, receiving an introduction (e.g., may include an introduction message, a sending profile, an introduction profile, a receiving profile, and/or an acceptance status, etc.) of the first of the profiles from the sending profile to a third of the profiles corresponding to the receiving profile, sending the introduction to the receiving profile, receiving an acceptance of the introduction from the receiving profile, and creating a connection between the first of the profiles and the receiving profile based on the acceptance.

In addition, the method may include obtaining the introduction including an introduction profile and a receiving profile from a first of the profiles, sending the introduction of a second of the profiles corresponding to the introduction profile to a third of the profiles corresponding to the receiving profile, receiving an acceptance of the introduction from the receiving profile, and creating a connection between the introduction profile and the receiving profile based on the acceptance.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a community network facilitating introductions between members in a neighborhood using a neighbor to neighbor relay, according to one embodiment.

FIG. 2A is a user interface view displaying profiles associated with neighbors of a member, according to one embodiment.

FIG. 2B is a user interface view facilitating the introduction of the neighbor associated with the member in the neighborhood, according to one embodiment.

FIG. 2C is a user interface view displaying the neighbor to neighbor relay associated with the member, according to one embodiment.

FIG. 3A is a block diagram representation illustrating information associated with a profile in the community network, according to one embodiment.

FIG. 3B is a block diagram representation illustrating information associated with the neighbor to neighbor relay in the community network, according to one embodiment.

FIG. 3C is a block diagram representation illustrating the neighbor to neighbor introduction, according to one embodiment.

FIG. 4 is a flowchart to facilitate the introductions between the profiles using the neighbor to neighbor relay, according to one embodiment.

FIG. 5 is a flowchart to create connections between the profiles associated with the introduction, according to one embodiment.

FIG. 6 is a diagrammatic system view of a data processing system in which any of the embodiments disclosed herein may be performed, according to one embodiment.

FIG. 7A is a process flow of facilitating the introduction between the member and the profile associated with the neighbor of the member, according to one embodiment.

FIG. 7B is a continuation of the process flow of FIG. 7A, illustrating additional processes, according to one embodiment.

FIG. 7C is a continuation of the process flow of FIG. 7B, illustrating additional processes, according to one embodiment.

FIG. 8A is a process flow of facilitating the connections between the profiles in the community network using the neighbor to neighbor relay, according to one embodiment.

FIG. 8B is a continuation of the process flow of FIG. 8A, illustrating additional processes, according to one embodiment.

FIG. 8C is a continuation of the process flow of FIG. 8B, illustrating additional processes, according to one embodiment.

Other features of the present embodiments will be apparent from the accompanying drawings and from the detailed description that follows.

### DETAILED DESCRIPTION

A method and system of neighbor to neighbor relay in a geo-spatial environment are disclosed. In the following description, for the purposes of explanation, numerous specific details are set forth in order to provide a thorough understanding of the various embodiments. It will be evident, however to one skilled in the art that the various embodiments may be practiced without these specific details.

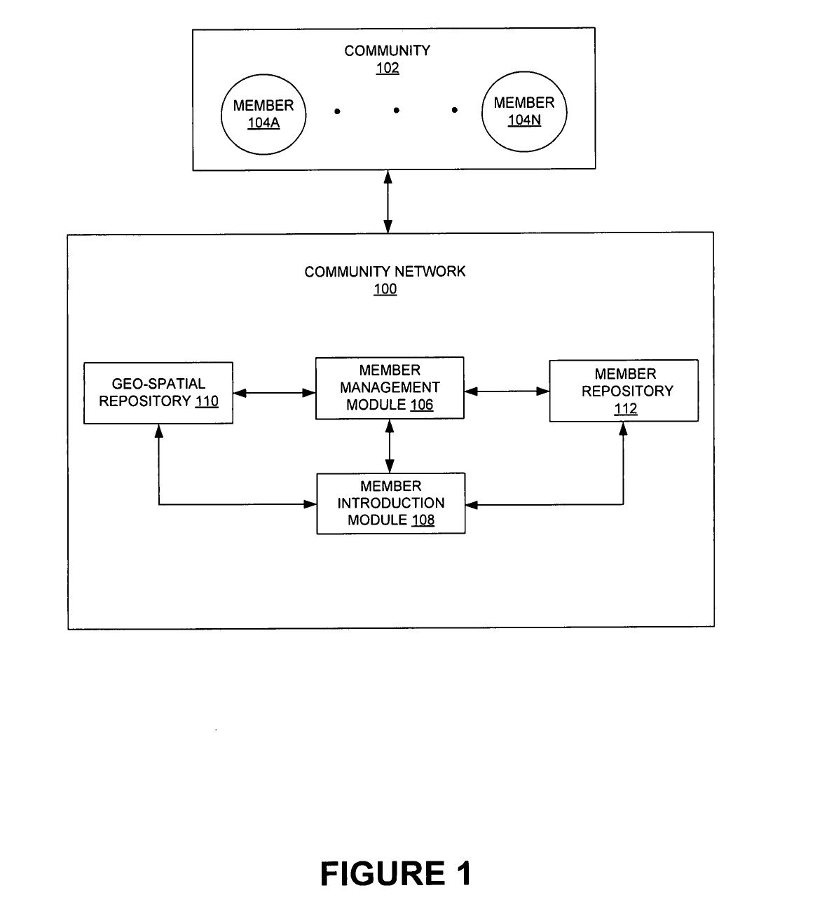

In one embodiment, a method of managing a community network (e.g., the community network 100 of FIG. 1) includes obtaining member data associated with a member 104 (e.g., of the members 104A-N of FIG. 1) of the community network 100 (e.g., using the member management module 106 of FIG. 1), determining a location of the member 104 based on the member data, storing the member data in a member repository (e.g., the member repository 112 of FIG. 1), obtaining a number of profiles in the community network 100 corresponding to a number of neighbors of the member 104 based on the member data and the location.

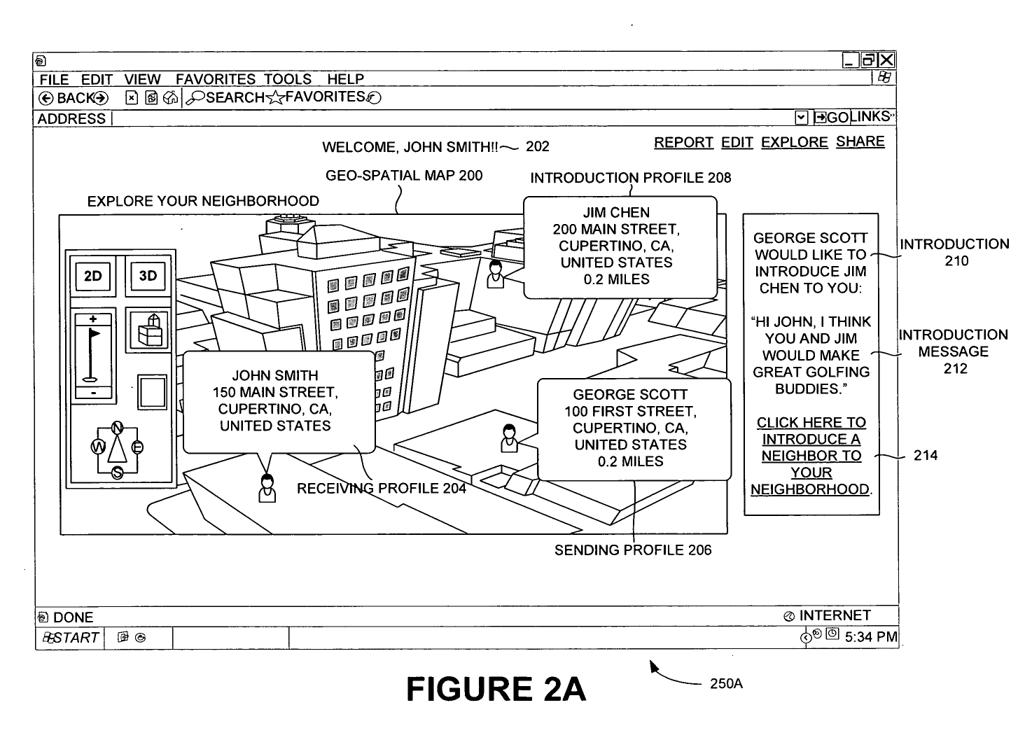

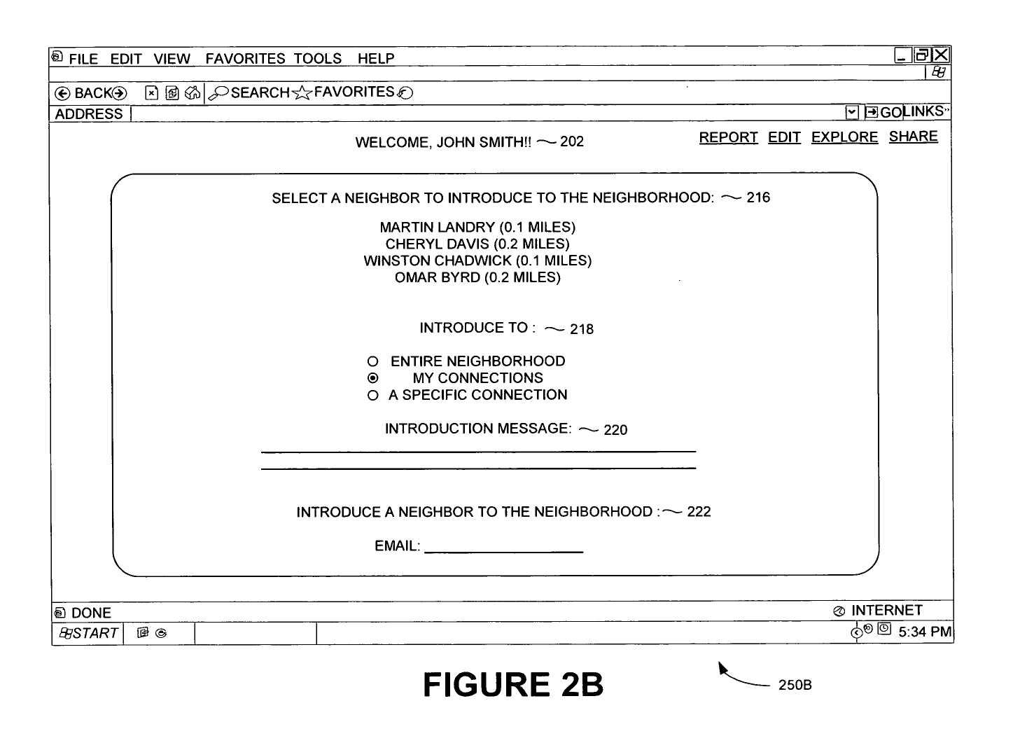

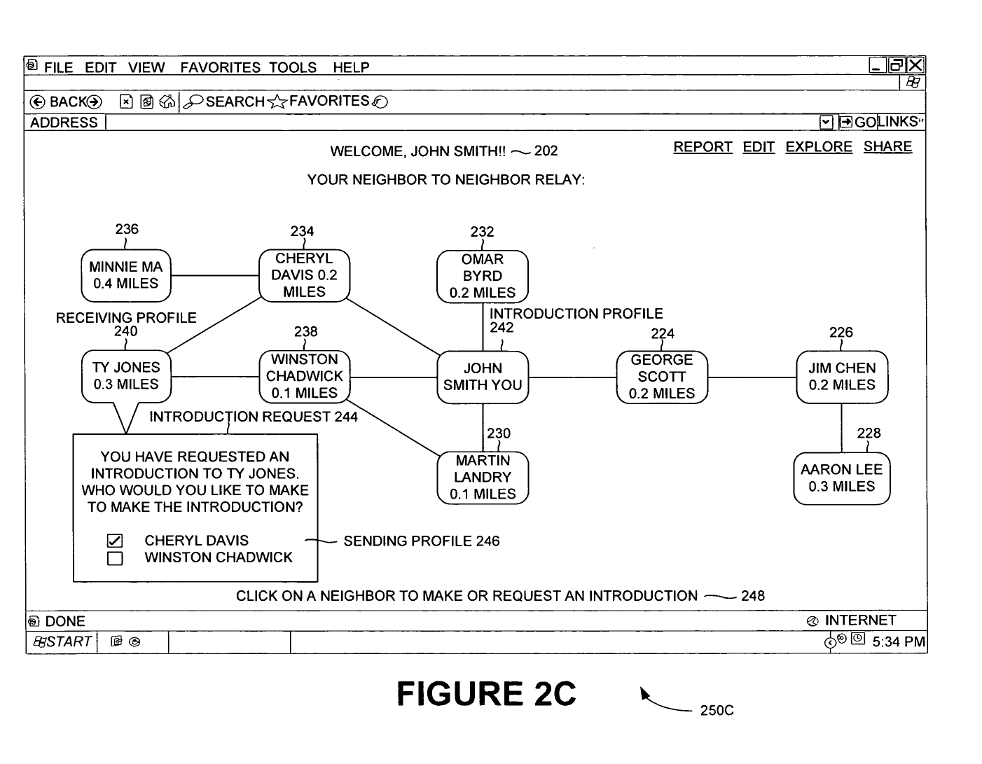

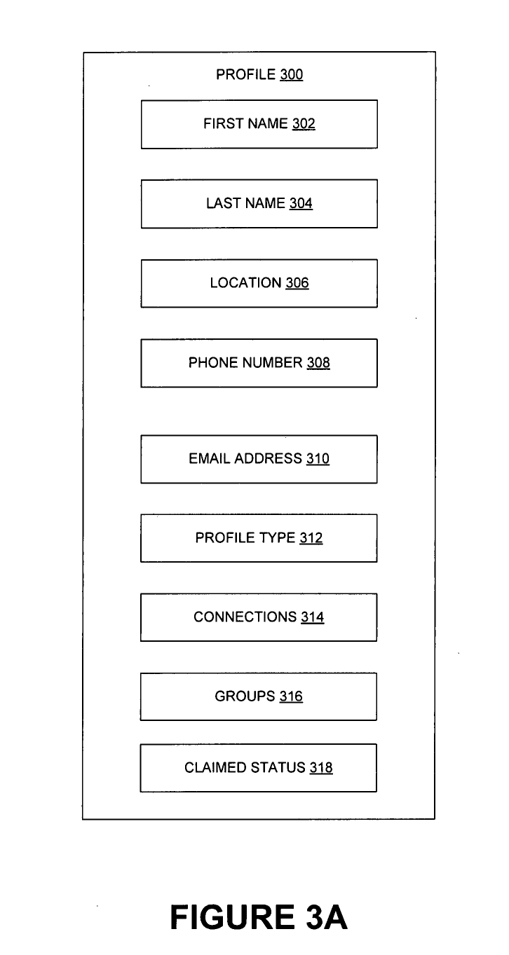

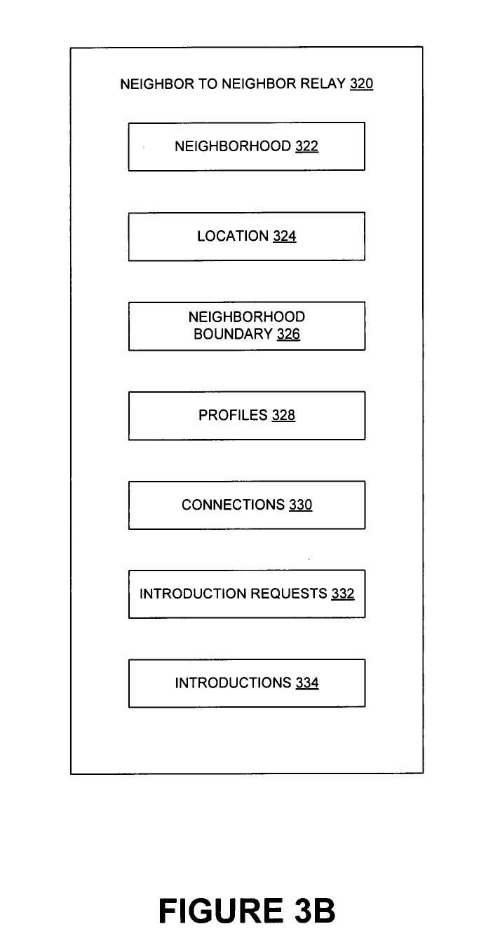

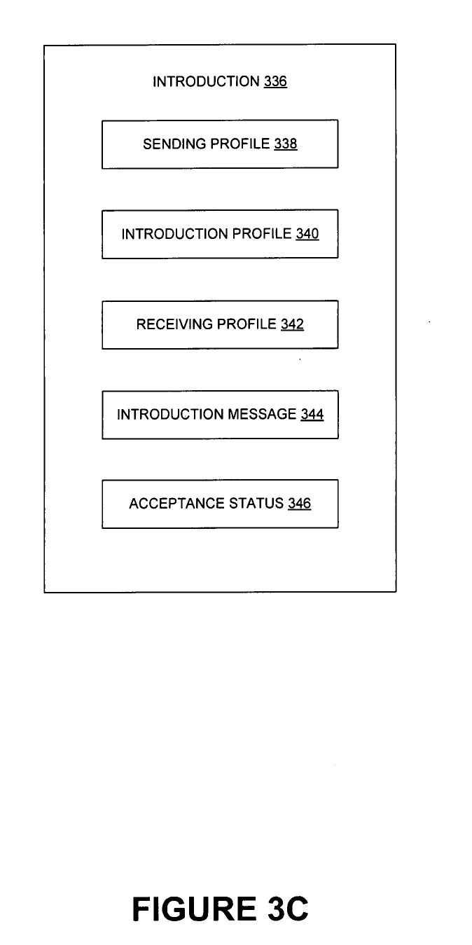

The method also includes generating (e.g., using the member introduction module 108 of FIG. 1) a neighbor to neighbor introduction (e.g., the introduction 336 of FIG. 3C) using the member data and the profiles by forming a chain between neighbors such that one neighbor introduces a group (e.g., the groups 316 of FIG. 3A) formed between neighbors in the chain to another neighbor such that a neighbor to neighbor relay (e.g., as illustrated in FIG. 2C) is formed in a geo-spatial social network (e.g., the community network 100 of FIG. 1), and facilitating the introduction 336 between the member 104 and a profile using the neighbor to neighbor relay 320 (e.g., using the member introduction module 108 of FIG. 1).

In another embodiment, a community network (e.g., the community network 100 of FIG. 1) includes a member repository (e.g., the member repository 112 of FIG. 1) including a number of members 104A-N, a geo-spatial repository (e.g., the geo-spatial repository 110 of FIG. 1) including a number of locations on a geo-spatial map (e.g., the geo-spatial map 200 of FIGS. 2A, 2B and 2C), a member management module (e.g., the member management module 106 of FIG. 1) configured to obtain member data (e.g., may include a location) associated with each of the members 104A-N.

The community network also includes a member introduction module (e.g., the member introduction module 108 of FIG. 1) configured to obtain a subset of the members 104A-N corresponding to a number of neighbors of a member 104 based on the member data and the location, generate a neighbor to neighbor relay (e.g., the neighbor to neighbor relay 320 of FIG. 3B) using the member data and the subset of the members 104A-N, display the neighbor to neighbor relay (e.g., as illustrated in FIG. 2C) to the member 104, and facilitate an introduction (e.g., the introduction 336 of FIG. 3C) between the member 104 and a subset of the members 104A-N using the neighbor to neighbor relay 320.

In yet another embodiment, a method of managing a community network (e.g., the community network 100 of FIG. 1) includes obtaining (e.g., using the member introduction module 108 of FIG. 1) a neighborhood in the community network 100, obtaining a location of the neighborhood, obtaining (e.g., using the member introduction module 108 of FIG. 1) a neighborhood boundary corresponding to the neighborhood, determining a number of profiles in the community network 100 corresponding to the neighborhood based on the location and the neighborhood boundary, obtaining (e.g., using the member introduction module 108 of FIG. 1) a number of connections corresponding to the profiles, generating (e.g., using the member introduction module 108 of FIG. 1) a neighbor to neighbor relay (e.g., as illustrated in FIG. 2C) using the profiles and the connections, and facilitating introductions (e.g., the introduction 336 of FIG. 3C) between the profiles using the neighbor to neighbor relay 320 (e.g., using the member introduction module 108 of FIG. 1).

FIG. 1 is a system view of a community network 100 facilitating introductions 336 between members in a neighborhood using a neighbor to neighbor relay (e.g., as illustrated in FIG. 2C), according to one embodiment. Particularly, FIG. 1 illustrates the community network 100, a community 102, members 104A-N, a member management module 106, a member introduction module 108, a geo-spatial repository 110 and a member repository 112, according to one embodiment.

The community network 100 may be a network formed by association of the members 104A-N having user profiles in the community 102 (e.g., user profiles in a social network associated with the community 102). The user profiles may include information such as names, addresses, contact information (e.g., phone numbers, email addresses, etc.), pictures, and/or other personal information. The community 102 may be a group of members 104A-N residing in a specific region. For example, the specific region may be a local neighborhood, a suburb, a village, a city, a county, a state, a nation, and/or a group of nations, etc.

The members 104A-N may include persons, businesses and/or organizations associated with specific geographic locations in the community 102. In one embodiment, the members 104A-N may reside in multiple regions (e.g., multiple cities, states, countries, etc.). The members 104A-N may be connected through the community network 100 (e.g., accessible through a network connection such as the internet, a telecommunication network, etc.). The member management module 106 may obtain member data associated with the members 104A-N of the community 102. For example, the member data may include names, ages, professions, locations and/or address data associated with the members 104A-N. The member data may be displayed in the user profiles of the members 104A-N.

The member introduction module 108 may facilitate introductions 336 between the members 104A-N of the community network 100 using the neighbor to neighbor relay (e.g., as illustrated in FIG. 2C). The geo-spatial repository 110 may be a database containing location information of the members 104A-N. For example, locations associated with the members 104A-N may be obtained based on the member data stored in the member repository 112. The member repository 112 may be a database containing member data associated with the members 104A-N of the community 102.

In one embodiment, member data associated with a member 104 of the community network 100 may be obtained and a location of the member 104 may be determined based on the member data. The member data may be stored in the member repository 112. The profiles in the community network 100 corresponding to neighbors of the member 104 may be obtained based on the member data and the location. The neighbor to neighbor introduction 336 (e.g., may include an introduction message, a sending profile, an introduction profile, a receiving profile, and/or an acceptance status, etc.) may be generated using the member data and the profiles by forming a chain between neighbors such that one neighbor introduces a group (e.g., the groups 316 of FIG. 3A) formed between neighbors in the chain to another neighbor such that the neighbor to neighbor relay (e.g., as illustrated in FIG. 2) is formed in a geo-spatial social network (e.g., the community network 100 of FIG. 1).

The introduction 336 between the member 104 and a profile may be facilitated using the neighbor to neighbor relay 320. In one embodiment, the profiles and the member data may be displayed on the geo-spatial map 200. For example, the member repository 112 may include a number of members 104A-N and the geo-spatial repository 110 may include a number of locations on the geo-spatial map 200. The member management module 106 may be configured to obtain member data (e.g., may include a location) associated with each of the members 104A-N. The member introduction module 108 may be configured to obtain a subset of the members 104A-N corresponding to neighbors of a member 104 (e.g., of the members 104A-N) based on the member data and the location. The neighbor to neighbor relay 320 may be generated using the member data and the members 104A-N.

In one embodiment, the neighbor to neighbor relay 320 may be displayed (e.g., as illustrated in FIG. 2C) to the member 104. An introduction 336 (e.g., may include an introduction message, a sending profile, an introduction profile, a receiving profile, and/or an acceptance status, etc.) between the member 104 and a subset of the members 104A-N may be facilitated using the neighbor to neighbor relay 320. The geo-spatial repository 110 may be configured to display the subset of the members 104A-N and the member data on a geo-spatial map 200. In one embodiment, the member introduction module 108 may be configured to obtain an introduction request (e.g., the introduction request 244 of FIG. 2C) including a sending profile (e.g., the sending profiles 206, 246 of FIGS. 2A, 2C) and a receiving profile (e.g., the receiving profiles 204, 240 of FIGS. 2A, 2C) from the member 104.

The introduction request 244 may be sent to a first of the subset corresponding to the sending profile 246. The introduction 336 of the member 104 may be received from the first of the subset to a second of the subset corresponding to the receiving profile 240. The introduction 336 may be sent to the receiving profile 240. An acceptance of the introduction 336 may be received from the receiving profile 240 and a connection between the member 104 and the receiving profile 240 may be created based on the acceptance. In another embodiment, the member introduction module 108 may be configured to obtain the introduction 336 including an introduction profile (e.g., the introduction profiles 208, 242 of FIGS. 2A, 2C) and a receiving profile (e.g., the receiving profiles 204, 240 of FIGS. 2A, 2C) from the member 104. The introduction 336 of a first of the subset corresponding to the introduction profile 242 may be sent to a second of the subset corresponding to the receiving profile 240.

An acceptance of the introduction 336 may be received from the receiving profile 240 and a connection between the introduction profile 242 and the receiving profile 240 may be created based on the acceptance. In a further embodiment, the member introduction module 108 may be configured to obtain the introduction 336 from a first of the subset corresponding to a sending profile (e.g., the sending profiles 206, 246 of FIGS. 2A, 2C) of a second of the subset corresponding to an introduction profile (e.g., the introduction profiles 208, 242 of FIG. 2A, 2C). The introduction 336 may be sent to the member 104 and an acceptance of the introduction 336 may be received from the member 104. Further, a connection between the introduction profile 242 and the member 104 may be created based on the acceptance.

FIG. 2A is a user interface view 250A displaying profiles associated with the neighbors of the member 104, according to one embodiment. Particularly, FIG. 2 illustrates a geo-spatial map 200, a welcome message 202, a receiving profile 204, a sending profile 206, an introduction profile 208, an introduction 210, an introduction message 212 and an option 214, according to one embodiment.

The geo-spatial map 200 may display neighborhood profiles associated with the member 104. The welcome message 202 may display a unique identifier (e.g., first name, last name, username, code, etc.) of the member 104 associated with the webpage 250. The receiving profile 204 may be a profile associated with the neighbor (e.g., of the member 104) receiving introductions 336 in the neighborhood. The sending profile 206 may be a profile associated with the neighbor sending the introduction 336 to other neighbors in the neighborhood.

The introduction profile 208 may be associated with the neighbor who is being introduced in the neighborhood. The introduction 210 may be associated with the sending profile 206 in the neighborhood. For example, the introduction 210 may include an introduction message 212, the sending profile 206, the introduction profile 208, the receiving profile 204, acceptance status, etc. The introduction message 212 may display a note that introduces the neighborhood profiles to the receiving profile 204. The option 214 may facilitate the introductions 336 between the neighbors using the neighbor to neighbor relay 320.

In the example embodiment illustrated in FIG. 2A, the geo-spatial map 200 displays various profiles introduced in the neighborhood. The introduction profile 208 is associated with Jim Chen who is introduced to John Smith, residing in the neighborhood of George Scott, associated with the sending profile 206.

In one embodiment, an introduction request 244 including the sending profile 206 and the receiving profile 204 may be obtained from the member 104. The introduction request 244 may be sent to a first of the profiles corresponding to the sending profile 206. An introduction 336 of the member 104 may be received from the first of the profiles to a second of the profiles corresponding to the receiving profile 204 and sent to the receiving profile 204 and an acceptance of the introduction 336 may be received from the receiving profile 204. Further, a connection between the member 104 and the receiving profile 204 may be created based on the acceptance.

The introduction 336 including the introduction profile 208 and the receiving profile 204 may be obtained from the member 104. The introduction 336 of a first of the profiles corresponding to the introduction profile 208 may be sent to a second of the profiles corresponding to the receiving profile 204 and an acceptance of the introduction profile 208 may be received from the receiving profile 204. Further, a connection between the introduction profile 208 and the receiving profile 204 may be created based on the acceptance.

The introduction 336 may be obtained from a first of the profiles corresponding to the sending profile 206 of a second of the profiles corresponding to the introduction profile 208 and the introduction 336 may be sent to the member 104. Further, an acceptance of the introduction 336 may be received from the member 104 and a connection between the introduction profile 208 and the member 104 may be created based on the acceptance.

FIG. 2B is a user interface view 250B facilitating introduction 336 of the neighbor associated with the member 104 in the neighborhood, according to one embodiment. Particularly, FIG. 2B illustrates the welcome message 202, a select option 216, an option 218, an introduction message 220 and an option 222, according to one embodiment.

The select option 216 may enable selection of neighbors to be introduced in the neighborhood. The option 218 may enable selection of connections that receive the introductions 336. For example, the neighbor may be introduced to the entire neighborhood, to specific connections, etc. The introduction message 220 may display a message, a note, etc. that introduces the neighbors in the community network 100. The option 222 may enable sending of introductions 336 to the neighbors. For example, e-mail addresses of the neighbors may be entered in the e-mail field (e.g., illustrated in FIG. 2B) to send the introductions 336.

In the example embodiment illustrated in FIG. 2B, the user interface view 250B displays the welcome message 202 associated with John Smith. John Smith may select neighbors to introduce in his neighborhood through the select option 216. John Smith may introduce the selected neighbors to entire neighborhood, his connections or to specific connections in the neighborhood. For example, the introduction message 220 may be sent to the selected connections using the option 222 by entering valid e-mail addresses.

FIG. 2C is a user interface view 250C displaying a neighbor to neighbor relay (e.g., the neighbor to neighbor relay 320 of FIG. 3B) associated with the member 104, according to one embodiment. Particularly, FIG. 2C illustrates the welcome message 202, profile blocks 224-242, an introduction request 244, a sending profile 246 and an option 248, according to one embodiment.

The profile blocks 224-242 may display profile information associated with the neighbors of the member 104 who are introduced and connected to each other. The introduction request 244 may ask for introductions 336 to be made between the neighbors associated with the members 104A-N of the community network 100. The option 248 may enable making or requesting an introduction 336 in the neighborhood so that the neighbors stay connected.

In the example embodiment illustrated in FIG. 2C, the user interface view 250C displays the neighbor to neighbor relay. For example, John Smith may send the introduction request 244 to selected neighbors. John Smith may also make an introduction about himself using the option 248.

In one embodiment, a neighborhood in the community network 100 may be obtained. A location of the neighborhood may be obtained. A neighborhood boundary may be obtained corresponding to the neighborhood. A number of profiles in the community network 100 corresponding to the neighborhood may be determined based on the location and the neighborhood boundary. A number of connections corresponding to the profiles may be obtained. The neighbor to neighbor relay (e.g., as illustrated in FIG. 2C) may be generated using the profiles and the connections.

Introductions 336 (e.g., may include an introduction message, a sending profile, an introduction profile, a receiving profile, and an acceptance status) between the profiles may be facilitated using the neighbor to neighbor relay 320. An introduction request (e.g., the introduction request 244 of FIG. 2C) including the sending profile 246 and the receiving profile 240 may be received from a first of the profiles. The introduction request 244 may be sent to a second of the profiles corresponding to the sending profile 246. The introduction 336 of the first of the profiles may be received from the sending profile 246 to a third of the profiles corresponding to the receiving profile 240. The introduction 336 may be sent to the receiving profile 240 and an acceptance of the introduction 336 may be received from the receiving profile 240.

Further, a connection between the first of the profiles and the receiving profile 240 may be created based on the acceptance. The introduction 336 including the introduction profile 242 and the receiving profile 240 may be received from a first of the profiles. The introduction 336 of a second of the profiles corresponding to the introduction profile 242 may be sent to a third of the profiles corresponding to the receiving profile 240. An acceptance of the introduction 336 may be received from the receiving profile 240 and a connection between the introduction profile 242 and the receiving profile 240 may be created based on the acceptance.

FIG. 3A is a block diagram representation illustrating information associated with a profile 300 in the community network 100, according to one embodiment. Particularly, FIG. 3A illustrates a first name block 302, a last name block 304, a location block 306, a phone number block 308, an email address block 310, a profile type block 312, a connections block 314, a groups block 316 and a claimed status block 318, according to one embodiment.

The block diagram may display a first name of a member 104 in the first name block 302, a last name of the member 104 in the last name block 304, a location information in the location block 306, a phone number in the phone number block 308, an email address associated with the member 104 in the email address block 310. For example, the member 104 may be an individual having a profile 300 (e.g., a claimed or an unclaimed profile) in the community network 100.

The profile type block 312 may display details associated with types of the profiles of the neighbors (e.g., a person, a business, and/or an organization, etc.). The connections block 314 may display a list of neighbors to which the member 104 of the group is connected (e.g., based on introductions). The groups block 316 may display groups in the neighborhood formed or joined by the member 104. In one embodiment, the groups may be formed by forming a chain of neighbors connected to each other. The claimed status block 318 may indicate whether or not the member 104 of the group has claimed his/her profile.

In the example embodiment illustrated in FIG. 3A, the block diagram representation displays profile information associated with the member 104 who has formed the neighborhood group 316 in the community network 100. For example, the profile information may include first name, last name, location, phone number, email address, profile type, contacts, and/or groups, etc.

FIG. 3B is a block diagram representation illustrating information associated with a neighbor to neighbor relay 320 in the community network 100, according to one embodiment. Particularly, FIG. 3B illustrates a neighborhood block 322, a location block 324, a neighborhood boundary block 326, a profiles block 328, a connections block 330, an introduction requests block 332 and an introductions block 334, according to one embodiment.

The neighborhood block 322 may display neighborhoods associated with the member 104 in the community network 100. The location block 324 may display a location of the neighborhood based on member data associated with the neighbors. The neighborhood boundary block 326 may display a border line within which the neighborhood is specified in the community network 100. The profiles block 328 may display profiles in the community network 100 that are associated with the neighborhood. The connections block 330 may display connections formed in the community network 100 based on the neighbor to neighbor relay 320. The requests for introducing the neighbors and the introductions 336 made by the neighbors are displayed in the introduction requests block 332 and the introductions block 334.

In the example embodiment illustrated in FIG. 3B, the block diagram representation illustrates the neighbor to neighbor relay 320 formed in the community network 100 based on introductions 336 and connections in the neighborhood.

FIG. 3C is a block diagram representation illustrating a neighbor to neighbor introduction 336, according to one embodiment. Particularly, FIG. 3C illustrates a sending profile block 338, an introduction profile block 340, a receiving profile block 342, an introduction message block 344 and an acceptance status block 346, according to one embodiment.

The sending profile block 338 may display profiles associated with neighbors sending the introduction 336 to other neighbors in the neighborhood. The introduction profile block 340 may display profiles associated with a neighbor who is being introduced in the neighborhood. The receiving profile block 342 may display profiles associated with neighbors receiving introductions 336 about other neighbors in the neighborhood. The introduction message block 344 may display messages that introduce a neighbor to other neighbors. The acceptance status block 346 may display whether or not a neighbor has accepted the introduction 336 of another neighbor.

In the example embodiment illustrated in FIG. 3C, the block diagram representation illustrates the introduction 336 facilitated between the neighbors using the neighbor to neighbor relay 320 in the community network 100.

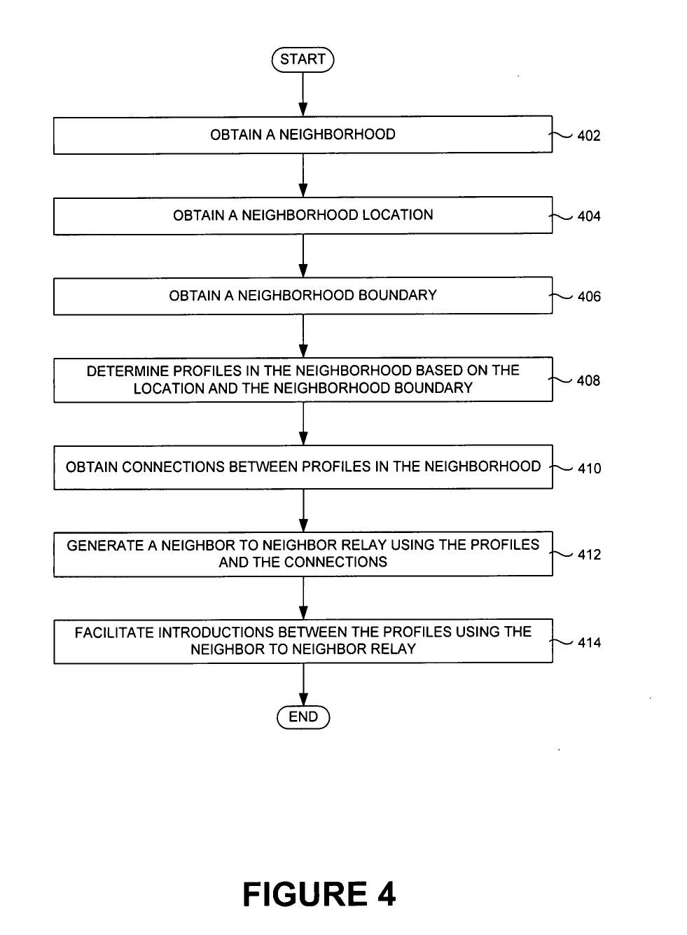

FIG. 4 is a flowchart to facilitate introductions 336 between profiles using a neighbor to neighbor relay 320, according to one embodiment. In operation 402, a neighborhood in a community network 100 is obtained. In operation 404, a neighborhood location is obtained (e.g., using the geo-spatial repository 110 of FIG. 1). In operation 406, a neighborhood boundary is obtained (e.g., using the member introduction module 108 of FIG. 1). In operation 408, profiles in the neighborhood are determined (e.g., using the member management module 106 of FIG. 1) based on the location and the neighborhood boundary. In operation 410, connections between the profiles in the neighborhood are obtained (e.g., using the member introduction module 108 of FIG. 1).

In operation 412, the neighbor to neighbor relay 320 is generated (e.g., through the member introduction module 108 of FIG. 1) using the profiles in the neighborhood and the connections associated with the profiles. In operation 414, introductions 336 between the profiles are facilitated (e.g., through the member introduction module 108 of FIG. 1) using the neighbor to neighbor relay 320. For example, the introduction 336 may include an introduction message, a sending profile, an introduction profile, a receiving profile, and an acceptance status, etc.

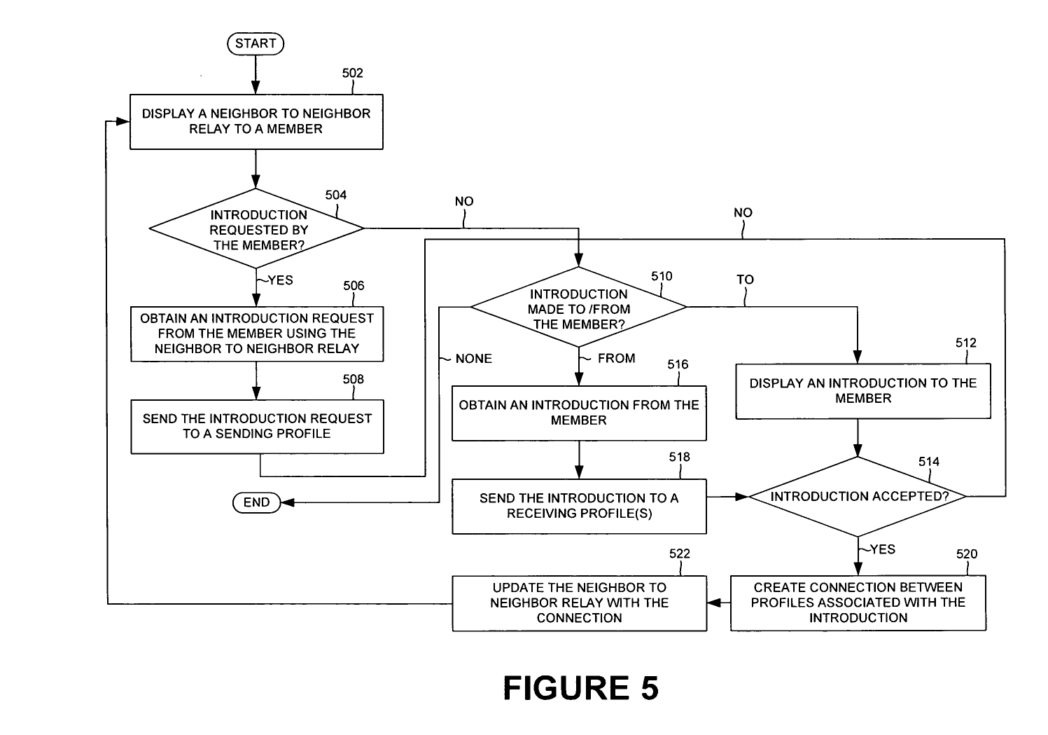

FIG. 5 is a flowchart to create connections between profiles associated with introductions 336, according to one embodiment. In operation 502, a neighbor to neighbor relay (e.g., as illustrated in FIG. 2C) is displayed (e.g., using the member introduction module 108 of FIG. 1) to a member 104 on a geo-spatial map (e.g., the geo-spatial map 200 of FIGS. 2A, 2B and 2C). In operation 504, it is determined whether or not the member 104 wishes to request an introduction 336. If the introduction 336 is requested by the member, then introduction request (e.g., the introduction request 244 of FIG. 2C) is obtained from the member 104 using the neighbor to neighbor relay 320 in operation 506, else operation 510 is performed. In operation 508, the introduction request 244 is sent to the first of profiles corresponding to the sending profile. In operation 510, it is determined whether an introduction 336 is to be made to or from the member 104.

The process may terminate if it is determined that the introduction 336 is neither made to the member 104 nor made from the member 104. If it is determined that the introduction 336 is to be made to the member 104, then operation 512 is performed. In operation 512, an introduction 336 is displayed to the member 104. In operation 514, it is determined whether or not the introduction 336 is accepted by the member 104. If it is determined that the introduction 336 is to be made from the member 104, then an introduction 336 is obtained from the member 104 in operation 516 (e.g., using the member management module 108 of FIG. 1). In operation 518, the introduction 336 is sent to the receiving profile(s). Again, operation 514 is performed to determine whether or not the introduction 336 is accepted by the receiving profile(s).

If the introduction 336 is accepted by the member 104 and the receiving profile(s), then a connection between the profiles associated with the introduction 336 is created in operation 520. If the introduction is not accepted, then operation 510 is repeated. In operation 522, the neighbor to neighbor relay 320 is updated with the connection. The process is then routed to operation 502 where the updated neighbor to neighbor relay 320 is displayed.

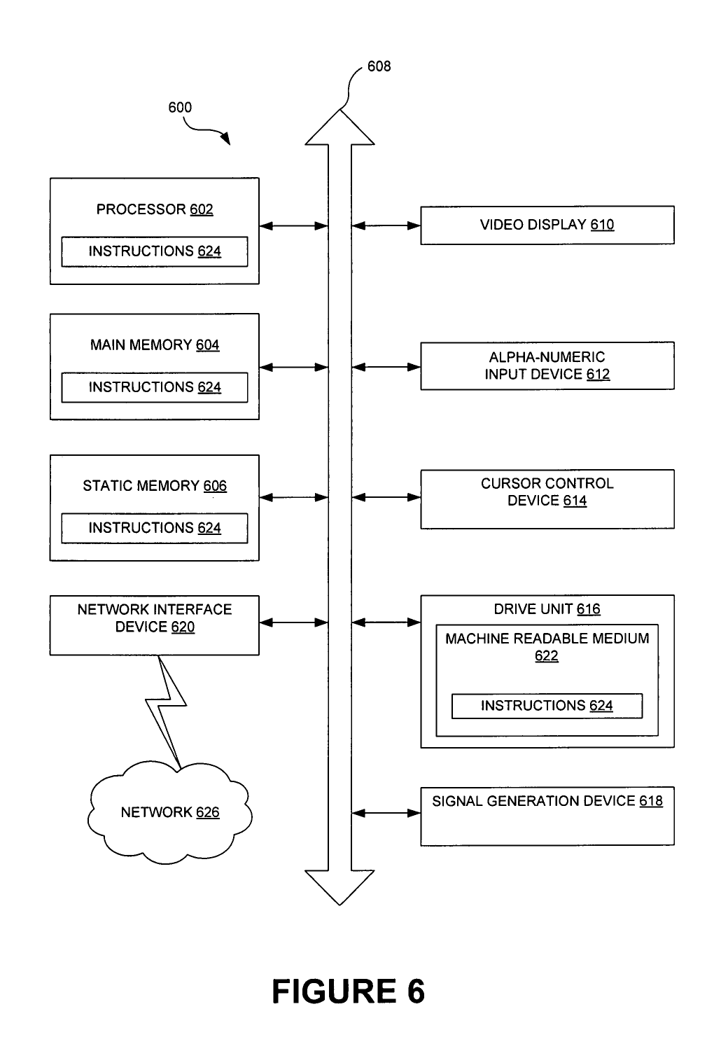

FIG. 6 is a diagrammatic system view 600 of a data processing system in which any of the embodiments disclosed herein may be performed, according to one embodiment. Particularly, the diagrammatic system view 600 of FIG. 6 illustrates a processor 602, a main memory 604, a static memory 606, a bus 608, a video display 610, an alpha-numeric input device 612, a cursor control device 614, a drive unit 616, a signal generation device 618, a network interface device 620, a machine readable medium 622, instructions 624 and a network 626, according to one embodiment.

The diagrammatic system view 600 may indicate a personal computer and/or a data processing system in which one or more operations disclosed herein are performed. The processor 602 may be microprocessor, a state machine, an application specific integrated circuit, a field programmable gate array, etc. The main memory 604 may be a dynamic random access memory and/or a primary memory of a computer system. The static memory 606 may be a hard drive, a flash drive, and/or other memory information associated with the data processing system.

The bus 608 may be an interconnection between various circuits and/or structures of the data processing system. The video display 610 may provide graphical representation of information on the data processing system. The alpha-numeric input device 612 may be a keypad, keyboard and/or any other input device of text (e.g., special device to aid the physically handicapped). The cursor control device 614 may be a pointing device such as a mouse. The drive unit 616 may be the hard drive, a storage system, and/or other longer term storage subsystem. The signal generation device 618 may be a bios and/or a functional operating system of the data processing system.

The network interface device 620 may be a device that may perform interface functions such as code conversion, protocol conversion and/or buffering required for communication to and from a network. The machine readable medium 622 may provide instructions on which any of the methods disclosed herein may be performed. The instructions 624 may provide source code and/or data code to the processor 602 to enable any one or more operations disclosed herein.

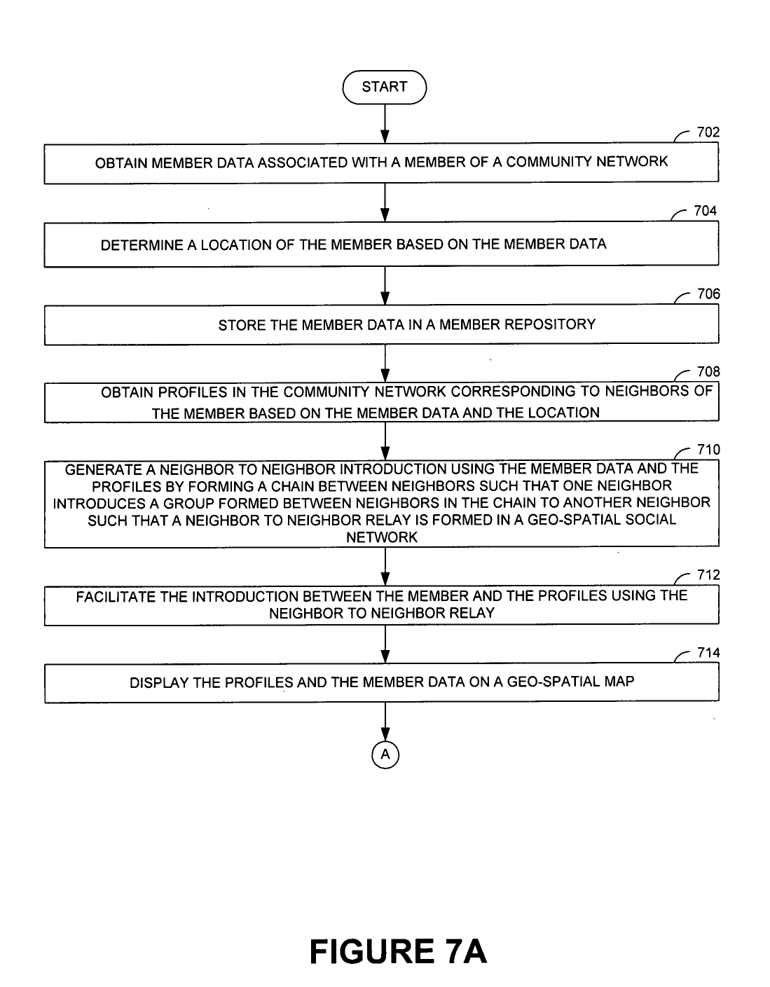

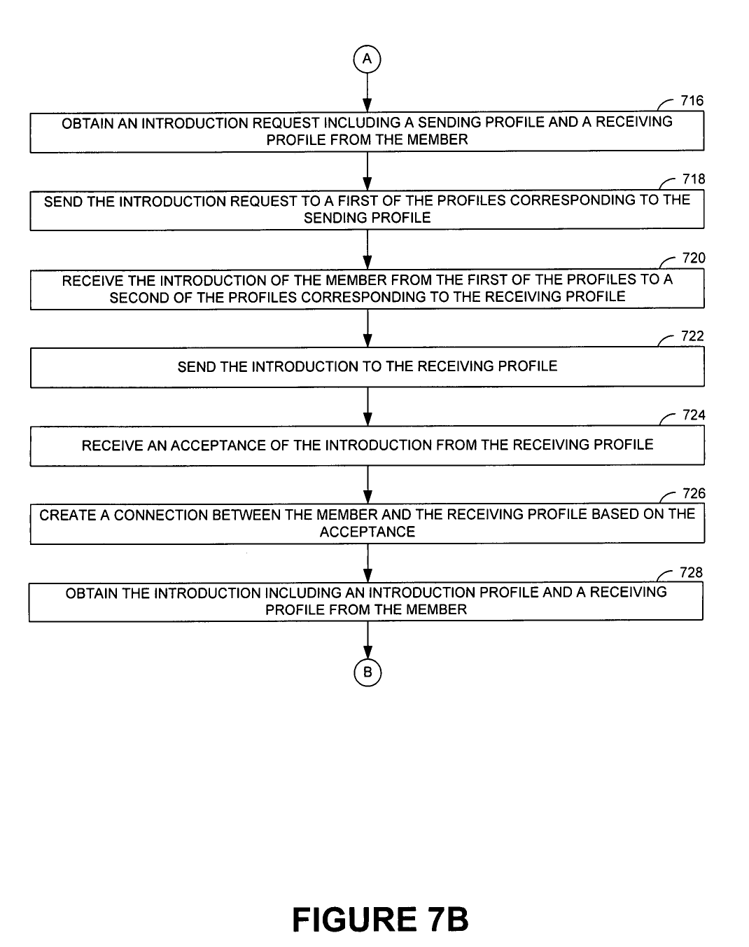

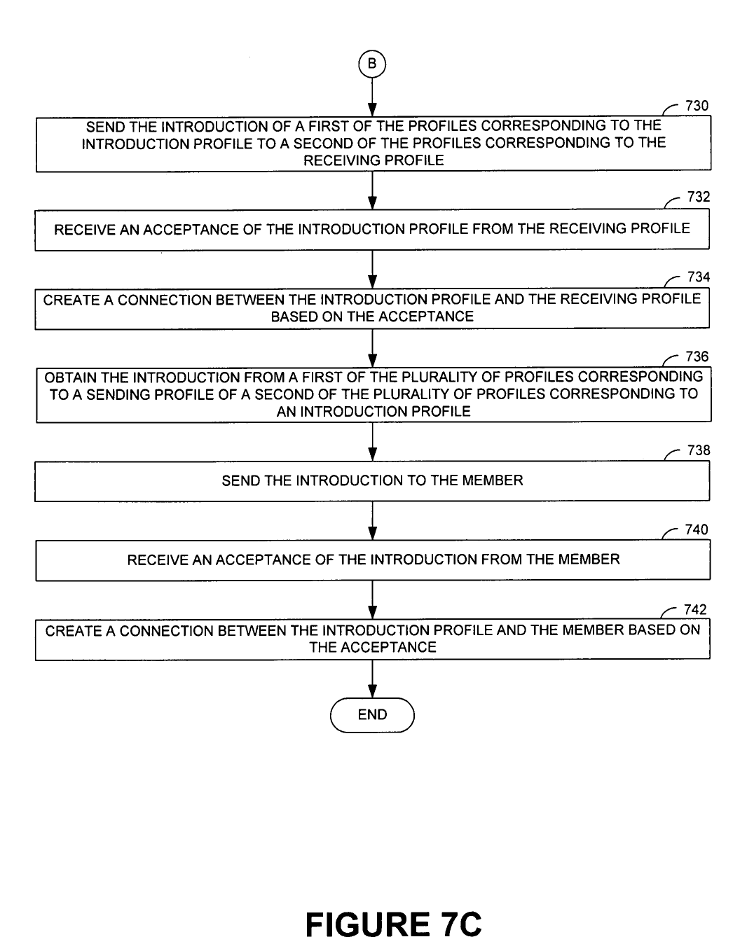

FIG. 7A is a process flow of facilitating an introduction 336 between a member 104 (e.g., of the community network 100) and a profile associated with a neighbor of the member 104, according to one embodiment. In operation 702, member data associated with the member 104 (e.g., of the members 104A-N) of the community network 100 may be obtained (e.g., using the member management module 106 of FIG. 1). In operation 704, a location of the member 104 may be determined (e.g., using the member management module 106 of FIG. 1) based on the member data. In operation 706, the member data may be stored in a member repository (e.g., the member repository 112 of FIG. 1). In operation 708, profiles in the community network 100 corresponding to neighbors of the member 104 may be obtained (e.g., using the member introduction module 108 of FIG. 1) based on the member data and the location.

In operation 710, a neighbor to neighbor introduction (e.g., the introduction 336 of FIG. 3C) may be generated (e.g., through the member introduction module 108 of FIG. 1) using the member data and the profiles by forming a chain between neighbors such that one neighbor introduces a group (e.g., the groups 316 of FIG. 3A) formed between the neighbors in the chain to another neighbor such that a neighbor to neighbor relay (e.g., the neighbor to neighbor relay 320 of FIG. 3B) is formed in a geo-spatial social network (e.g., the community network 100 of FIG. 1). In operation 712, the introduction 336 may be facilitated (e.g., using the member introduction module 108 of FIG. 1) between the member 104 and the profiles using the neighbor to neighbor relay 320. In operation 714, the profiles and the member data may be displayed (e.g., using the geo-spatial repository 110 of FIG. 1) on a geo-spatial map (e.g., the geo-spatial map 200 of FIGS. 2A, 2B and 2C).

FIG. 7B is a continuation of the process flow of FIG. 7A, illustrating additional processes, according to one embodiment. In operation 716, an introduction request (e.g., the introduction request 244 of FIG. 2C) including a sending profile (e.g., the sending profile 246 of FIG. 2C) and a receiving profile (e.g., the receiving profile 240 of FIG. 2C) may be obtained (e.g., using the member introduction module 108 of FIG. 1) from the member 104. In operation 718, the introduction request 244 may be sent (e.g., using the member introduction module 108 of FIG. 1) to a first of the profiles corresponding to the sending profile 246. In operation 720, the introduction 336 of the member 104 may be received (e.g., using the member introduction module 108 of FIG. 1) from the first of the profiles to a second of the profiles corresponding to the receiving profile 240.

In operation 722, the introduction 336 may be sent (e.g., using the member introduction module 108 of FIG. 1) to the receiving profile 240. In operation 724, an acceptance of the introduction 336 may be received (e.g., using the member introduction module 108 of FIG. 1) from the receiving profile 240. In operation 726, a connection between the member 104 and the receiving profile 240 may be created (e.g., using the member introduction module 108 of FIG. 1) based on the acceptance. In operation 728, the introduction 336 including an introduction profile (e.g., the introduction profile 242 of FIG. 2C) and a receiving profile 240 may be obtained (e.g., using the member introduction module 108 of FIG. 1) from the member 104.

FIG. 7C is a continuation of the process flow of FIG. 7B, illustrating additional processes, according to one embodiment. In operation 730, the introduction 336 of a first of the profiles corresponding to the introduction profile 242 may be sent (e.g., using the member introduction module 108 of FIG. 1) to a second of the profiles corresponding to the receiving profile 240. In operation 732, an acceptance of the introduction profile 242 may be received (e.g., using the member introduction module 108 of FIG. 1) from the receiving profile 240. In operation 734, a connection between the introduction profile 242 and the receiving profile 240 may be created (e.g., using the member introduction module 108 of FIG. 1) based on the acceptance.

In operation 736, the introduction 336 may be obtained (e.g., using the member introduction module 108 of FIG. 1) from a first of the profiles corresponding to a sending profile 246 of a second of the plurality of profiles corresponding to an introduction profile 242. In operation 738, the introduction 336 may be sent (e.g., using the member introduction module 108 of FIG. 1) to the member 104. In operation 740, an acceptance of the introduction 336 may be received (e.g., using the member introduction module 108 of FIG. 1) from the member 104. In operation 742, a connection between the introduction profile 242 and the member 104 may be obtained (e.g., using the member introduction module 108 of FIG. 1) based on the acceptance.

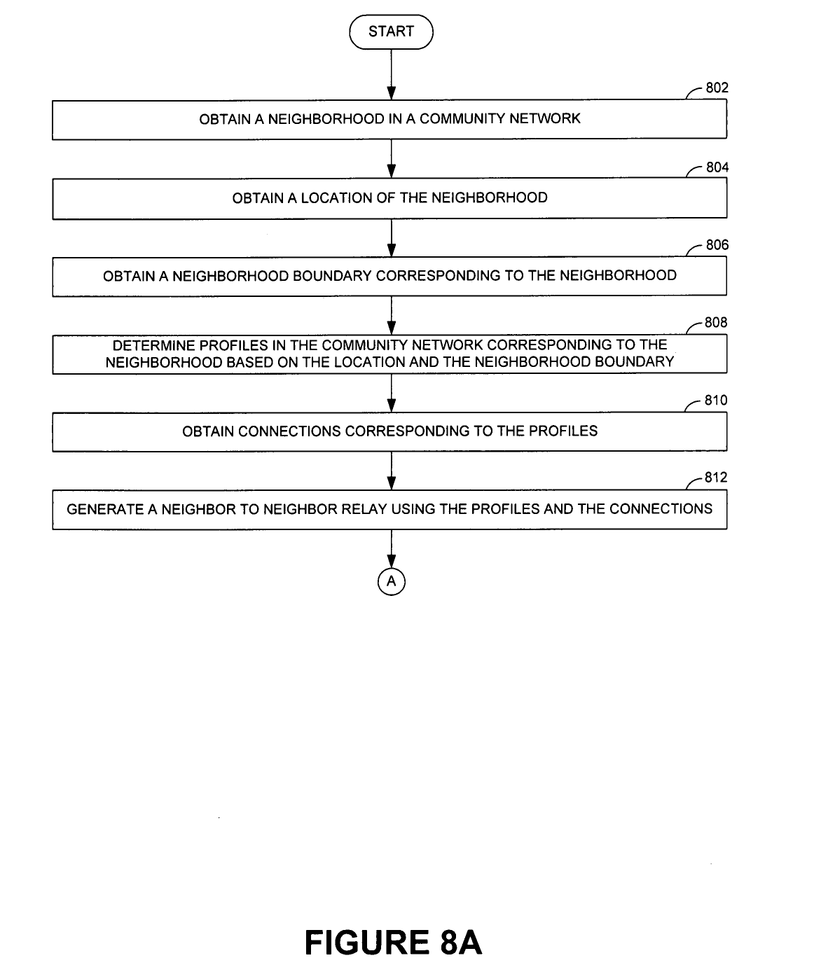

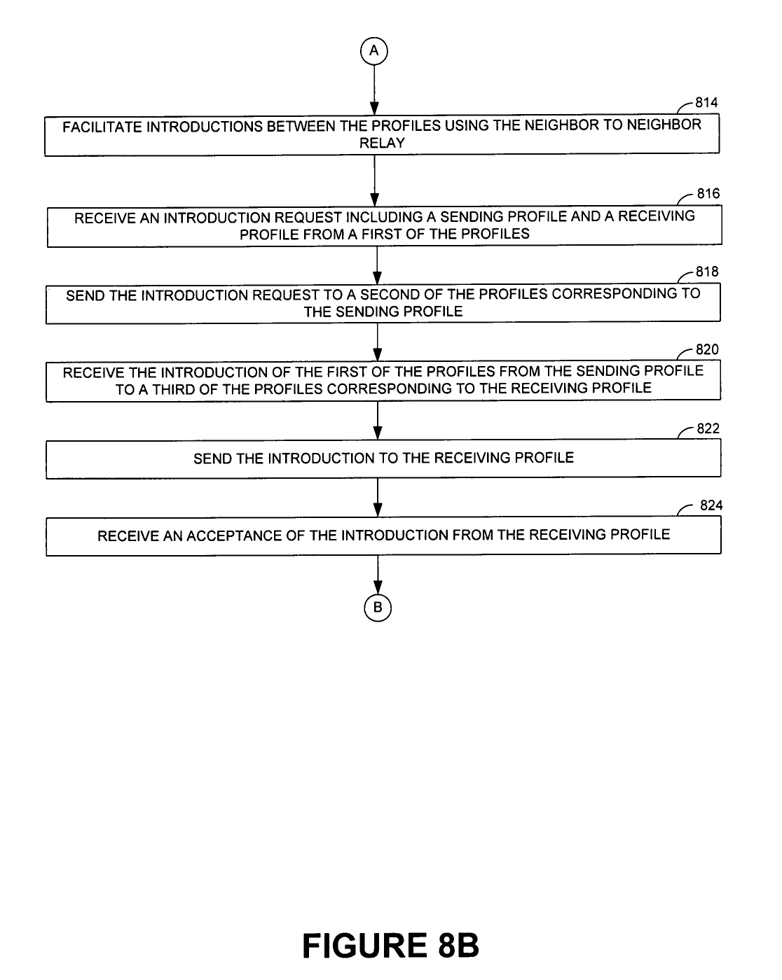

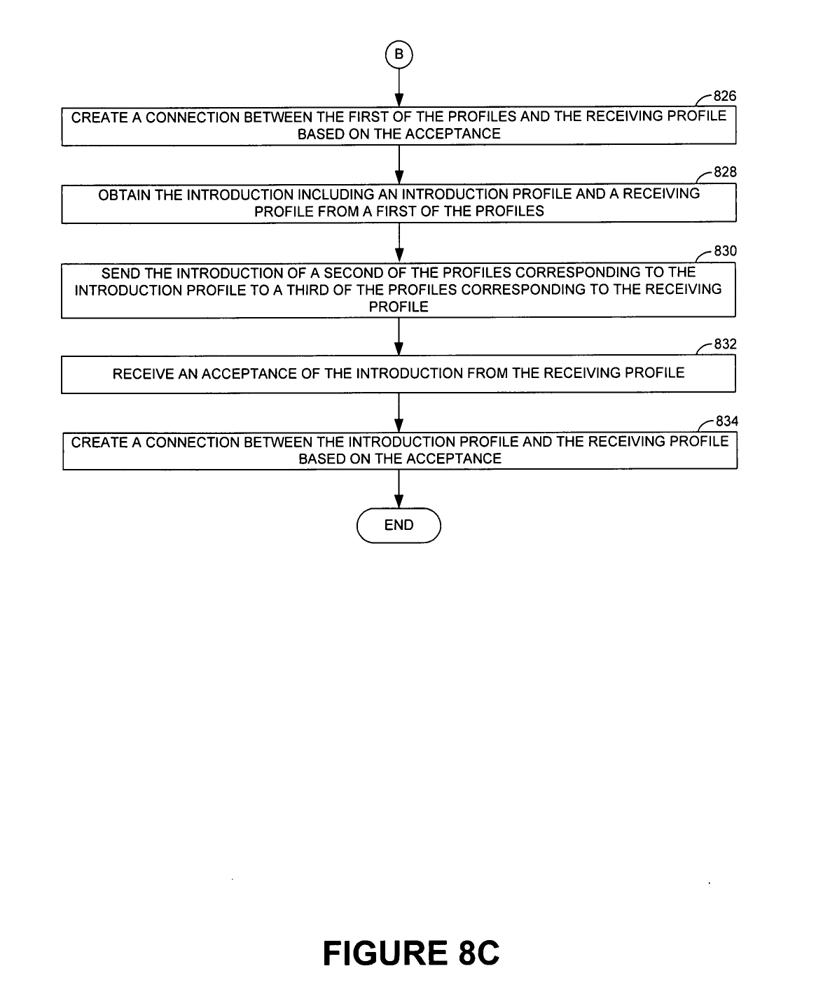

FIG. 8A is a process flow of facilitating connections between profiles in the community network 100 using a neighbor to neighbor relay (e.g., the neighbor to neighbor relay 320 of FIG. 3B), according to one embodiment. In operation 802, a neighborhood in the community network 100 may be obtained. In operation 804, a location of the neighborhood may be obtained (e.g., using the geo-spatial repository 110 of FIG. 1). In operation 806, a neighborhood boundary corresponding to the neighborhood may be obtained. In operation 808, profiles in the community network 100 corresponding to the neighborhood may be determined based on the location and the neighborhood boundary (e.g., using the member management module 106 of FIG. 1). In operation 810, connections corresponding to the profiles may be obtained. In operation 812, the neighbor to neighbor relay 320 may be generated using the profiles and the connections (e.g., using the member introduction module 108 of FIG. 1).

FIG. 8B is a continuation of the process flow of FIG. 8A, illustrating additional processes, according to one embodiment. In operation 814, introductions 336 may be facilitated between the profiles using the neighbor to neighbor relay 320. In operation 816, an introduction request (e.g., the introduction request 244 of FIG. 2C) including a sending profile (e.g., the sending profile 246 of FIG. 2C) and a receiving profile (e.g., the receiving profile 240 of FIG. 2C) may be received from a first of the profiles. In operation 818, the introduction request 244 may be sent to a second of the profiles corresponding to the sending profile 246. In operation 820, the introduction 336 of the first of the profiles may be received from the sending profile 246 to a third of the profiles corresponding to the receiving profile 240. In operation 822, the introduction 336 may be sent to the receiving profile 240 (e.g., using the member introduction module 108 of FIG. 1). In operation 824, an acceptance of the introduction 336 may be received from the receiving profile 240.

FIG. 8C is a continuation of the process flow of FIG. 8B, illustrating additional processes, according to one embodiment. In operation 826, a connection between the first of the profiles and the receiving profile 240 may be created based on the acceptance (e.g., using the member management module 106 of FIG. 1). In operation 828, the introduction 336 including an introduction profile (e.g., the introduction profile 242 of FIG. 2C) and a receiving profile (e.g., the receiving profile 240 of FIG. 2C) may be obtained from a first of the profiles. In operation 830, the introduction 336 of a second of the profiles corresponding to the introduction profile 242 may be sent to a third of the profiles corresponding to the receiving profile 240 (e.g., using the member introduction module 108 of FIG. 1). In operation 832, an acceptance of the introduction 336 may be received from the receiving profile 240. In operation 834, a connection between the introduction profile 242 and the receiving profile 240 may be created based on the acceptance (e.g., as illustrated in FIG. 2C).

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium).

For example, the various electrical structure and methods may be embodied using transistors, logic gates, and electrical circuits (e.g., Application Specific Integrated Circuitry (ASIC) and/or in Digital Signal Processor (DSP) circuitry). For example, the member management module 106, the member introduction module 108, and other modules of FIGS. 1-8 may be enabled using a member management circuit, a member introduction circuit, and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method of managing a community network, comprising:
obtaining member data associated with a member of the community network;
determining a location of the member based on the member data;
storing the member data in a member repository;
obtaining a plurality of profiles in the community network corresponding to a plurality of neighbors of the member based on the member data and the location;
generating a neighbor to neighbor introduction using the member data and the plurality of profiles by forming a chain between neighbors such that one neighbor introduces a group formed between neighbors in the chain to another neighbor such that a neighbor to neighbor relay is formed in a geo-spatial social network; and
facilitating the introduction between the member and at least one of the plurality of profiles using the neighbor to neighbor relay.

2. The method of claim 1, further comprising displaying the plurality of profiles and the member data on a geo-spatial map.

3. The method of claim 1, further comprising:
obtaining an introduction request comprising a sending profile and a receiving profile from the member;
sending the introduction request to a first of the plurality of profiles corresponding to the sending profile;
receiving the introduction of the member from the first of the plurality of profiles to a second of the plurality of profiles corresponding to the receiving profile; and
sending the introduction to the receiving profile.

4. The method of claim 3, further comprising:
receiving an acceptance of the introduction from the receiving profile; and
creating a connection between the member and the receiving profile based on the acceptance.

5. The method of claim 1, further comprising:
obtaining the introduction comprising an introduction profile and a receiving profile from the member; and
sending the introduction of a first of the plurality of profiles corresponding to the introduction profile to a second of the plurality of profiles corresponding to the receiving profile.

6. The method of claim 5, further comprising:
receiving an acceptance of the introduction profile from the receiving profile; and
creating a connection between the introduction profile and the receiving profile based on the acceptance.

7. The method of claim 1, further comprising:
obtaining the introduction from a first of the plurality of profiles corresponding to a sending profile of a second of the plurality of profiles corresponding to an introduction profile; and
sending the introduction to the member.

8. The method of claim 7, further comprising:
receiving an acceptance of the introduction from the member; and
creating a connection between the introduction profile and the member based on the acceptance.

9. The method of claim 1, wherein the introduction comprises an introduction message, a sending profile, an introduction profile, a receiving profile, and an acceptance status.

10. The method of claim 1 in a form of a machine-readable medium embodying a set of instructions that, when executed by a machine, causes the machine to perform the method of claim 1.

11. A community network, comprising:
a member repository comprising a plurality of members;
a geo-spatial repository comprising a plurality of locations on a geo-spatial map;
a member management module configured to obtain member data associated with each of the plurality of members, wherein the member data comprises one of the plurality of locations; and
a member introduction module configured to:
obtain a subset of the plurality of members corresponding to a plurality of neighbors of one of the plurality of members based on the member data and the one of the plurality of locations;
generate a neighbor to neighbor relay using the member data and the subset of the plurality of members;
display the neighbor to neighbor relay to the one of the plurality of members; and
facilitate an introduction between the one of the plurality of members and at least one of the subset of the plurality of members using the neighbor to neighbor relay.

12. The community network of claim 11, wherein the geo-spatial repository is configured to display the subset of the plurality of members and the member data on a geo-spatial map.

13. The community network of claim 11, wherein the member introduction module is further configured to:
obtain an introduction request comprising a sending profile and a receiving profile from the one of the plurality of members;
send the introduction request to a first of the subset corresponding to the sending profile;
receive the introduction of the member from the first of the subset to a second of the subset corresponding to the receiving profile;
send the introduction to the receiving profile;
receive an acceptance of the introduction from the receiving profile; and
create a connection between the one of the plurality of members and the receiving profile based on the acceptance.

14. The community network of claim 11, wherein the member introduction module is further configured to:
obtain the introduction comprising an introduction profile and a receiving profile from the one of the plurality of members;
send the introduction of a first of the subset corresponding to the introduction profile to a second of the subset corresponding to the receiving profile;
receive an acceptance of the introduction from the receiving profile; and
create a connection between the introduction profile and the receiving profile based on the acceptance.

15. The community network of claim 11, wherein the member introduction module is further configured to:
obtain the introduction from a first of the subset corresponding to a sending profile of a second of the subset corresponding to an introduction profile;
send the introduction to the one of the plurality of members;
receive an acceptance of the introduction from the one of the plurality of members; and
create a connection between the introduction profile and the one of the plurality of members based on the acceptance.

16. The community network of claim 11, wherein the introduction comprises an introduction message, a sending profile, an introduction profile, a receiving profile, and an acceptance status.

17. A method of managing a community network, comprising:
obtaining a neighborhood in the community network;
obtaining a location of the neighborhood;
obtaining a neighborhood boundary corresponding to the neighborhood;
determining a plurality of profiles in the community network corresponding to the neighborhood based on the location and the neighborhood boundary;
obtaining a plurality of connections corresponding to the plurality of profiles;
generating a neighbor to neighbor relay using the plurality of profiles and the plurality of connections; and
facilitating introductions between the plurality of profiles using the neighbor to neighbor relay.

18. The method of claim 17, further comprising:
receiving an introduction request comprising a sending profile and a receiving profile from a first of the plurality of profiles;
sending the introduction request to a second of the plurality of profiles corresponding to the sending profile;
receiving the introduction of the first of the plurality of profiles from the sending profile to a third of the plurality of profiles corresponding to the receiving profile;
sending the introduction to the receiving profile;
receiving an acceptance of the introduction from the receiving profile; and
creating a connection between the first of the plurality of profiles and the receiving profile based on the acceptance.

19. The method of claim 17, further comprising:
obtaining the introduction comprising an introduction profile and a receiving profile from a first of the plurality of profiles;
sending the introduction of a second of the plurality of profiles corresponding to the introduction profile to a third of the plurality of profiles corresponding to the receiving profile;
receiving an acceptance of the introduction from the receiving profile; and
creating a connection between the introduction profile and the receiving profile based on the acceptance.

20. The method of claim 17, wherein the introduction comprises an introduction message, a sending profile, an introduction profile, a receiving profile, and an acceptance status.
